(19) United States
(12) Patent Application Publication
(10) Pub. No.: US 2026/0091773 A1
(43) Pub. Date: Apr. 2, 2026

(54) ENGINE MISFIRE DIAGNOSIS SYSTEM AND METHOD AND A VEHICLE INCLUDING SAME

(71) Applicants: HYUNDAI MOTOR COMPANY, Seoul (KR); KIA CORPORATION, Seoul (KR)

(72) Inventor: Hyuk Im, Hwaseong-si (KR)

(73) Assignees: HYUNDAI MOTOR COMPANY, Seoul (KR); KIA CORPORATION, Seoul (KR)

(21) Appl. No.: 19/071,950

(22) Filed: Mar. 6, 2025

(30) Foreign Application Priority Data
Sep. 30, 2024 (KR) 10-2024-0132828

(51) Int. Cl. B60W 20/50; B60W 10/08; G01M 15/11

(52) U.S. Cl. CPC B60W 20/50; B60W 10/08; G01M 15/11; B60W 2510/0685; B60W 2710/083

(57) ABSTRACT

A system implemented to diagnose a misfire for each cylinder of an engine based on a crank rotation angle and a motor control torque, an engine misfire diagnosis method thereof, and a vehicle including the same are disclosed. The engine misfire diagnosis system includes an engine configured to output power based on supplied fuel, a crank rotation angle sensor provided on the engine to measure a crank rotation angle of the engine, a motor configured to generate electrical energy by receiving the power, and a controller configured to perform control of the engine and the motor. The controller is configured to diagnose a misfire for each cylinder of the engine based on the crank rotation angle and a motor control torque ouput to the motor when entering an engine power generation mode.

### CROSS REFERENCE TO RELATED APPLICATIONS

The present application claims the benefit of and priority under 35 U.S. C. § 119 to Korean Patent Application No. 10-2024-0132828, filed on Sep. 30, 2024, in the Korean Intellectual Property Office, the entire contents of which are hereby incorporated herein by reference.

### TECHNICAL FIELD

The present disclosure relates to an engine misfire diagnosis technology and, more particularly, to a system implemented to diagnose a misfire for each cylinder of an engine based on a crank rotation angle and a motor control torque, an engine misfire diagnosis method thereof, and a vehicle including the same.

### BACKGROUND

A vehicle is equipped with logic to diagnose misfires occurring in a vehicle engine. A conventional misfire diagnosis logic diagnoses misfires of an engine based on engine roughness corresponding to the rpm fluctuation of the engine.

Recently, a vehicle has been implemented to run by using two or more power sources (e.g., an engine and a motor) to achieve goals such as increasing driving distance and ensuring stable driving.

In the case of such a vehicle, a generator produces electricity based on power generated by the engine, and the electricity produced by the generator is provided to a motor. The motor drives a transmission to enable the vehicle to drive (a power generation mode).

Motor control (“speed control”) performed in the power generation mode of the vehicle reduces the rpm fluctuations of the engine, which reduces the accuracy of engine misfire diagnosis based on engine roughness.

The description provided in this Background section is intended merely to enhance understanding of the general background of the present disclosure and should not be construed as being included in the related art known by those having ordinary skill in the art to which the present disclosure pertains.

### SUMMARY

The present disclosure was made to solve the above-described problems occurring in the prior art while advantages achieved by the prior art are maintained intact. Embodiments of the present disclosure provide a system that improves the accuracy of engine misfire diagnosis of a vehicle including a power generation device (e.g., an engine and a motor), an engine misfire diagnosis method thereof, and a vehicle including the same.

Aa technical objective of the present disclosure is to provide a system implemented to improve the accuracy of misfire diagnosis for each cylinder of an engine, an engine misfire diagnosis method thereof, and a vehicle including the same.

Another technical objective of the present disclosure is to provide a system implemented to diagnose engine/cylinder misfire based on synchronization of a crank rotation angle and a motor control torque, an engine misfire diagnosis method thereof, and a vehicle including the same.

Still another technical objective of the present disclosure is to provide a system implemented to synchronize a crank rotation angle and a motor control torque, determine the engine torque correlation variable value based on the motor control torque, and diagnose a misfire based on the engine torque correlation variable value, an engine misfire diagnosis method thereof, and a vehicle including the same.

The technical objectives intended to be achieved in the present disclosure are not limited to the technical objectives mentioned above. Other technical objectives not mentioned herein should be more clearly understood by those having ordinary skill in the art to which the present disclosure pertains from the description below.

According to an embodiment of the present disclosure, an engine misfire diagnosis system is provided. The engine misfire diagnosis system includes: an engine configured to output power based on supplied fuel; a crank rotation angle sensor provided on the engine to measure a crank rotation angle of the engine; a motor configured to generate electrical energy by receiving the power; and a controller configured to perform control of the engine and the motor and to diagnose a misfire for each cylinder of the engine based on the crank rotation angle and a motor control torque ouput to the motor when entering an engine power generation mode.

According to an embodiment, the controller temporally may synchronize the crank rotation angle and the motor control torque, determine an engine torque correlation variable value based on the motor control torque, and diagnose the misfire for each cylinder based on the engine torque correlation variable value.

According to an embodiment, the controller may include: an engine controller configured to receive the crank rotation angle from the crank rotation angle sensor; and a motor controller configured to receive the crank rotation angle provided from the engine controller, to temporally synchronize the crank rotation angle and the motor control torque, and to determine the engine torque correlation variable value based on the motor control torque.

According to an embodiment, the motor controller may determine an engine cycle and a cycle of each cylinder based on change of the crank rotation angle, and determine the engine torque correlation variable value for each cylinder cycle.

According to an embodiment, the motor controller may determine the engine torque correlation variable value by integrating an amount of change of the motor control torque matching one cycle for each cylinder.

According to an embodiment, the motor controller may diagnose the misfire of the cylinder by comparing the engine torque correlation variable value with a preset misfire threshold.

According to an embodiment, the motor controller may provide the engine torque correlation variable value to the engine controller, and the engine controller may diagnose the misfire of the cylinder by comparing the engine torque correlation variable value with a preset misfire threshold.

According to an embodiment, the engine controller may determine crank angular acceleration based on the crank rotation angle, and diagnoses a misfire of the engine by comparing the crank angular acceleration with a preset misfire threshold.

According to an embodiment, the engine controller may provide the crank rotation angle to the motor controller when the crank angular acceleration is greater than or equal to the preset misfire threshold.

According to another embodiment of the present disclosure, an engine misfire diagnosis method is provided. The engine misfire diagnosis method includes: entering an engine power generation mode; controlling an engine and a motor configured to generate electrical energy based on power transmitted from the engine; and diagnosing a misfire for each cylinder of the engine based on a crank rotation angle measured by a crank rotation angle sensor provided on the engine and a motor control torque output to the motor.

According to an embodiment, the diagnosing may include: synchronizing the crank rotation angle and the motor control torque temporally; determining an engine torque correlation variable value based on the motor control torque; and diagnosing the misfire for each cylinder based on the engine torque correlation variable value.

According to an embodiment, the diagnosing may include: receiving, by an engine controller, the crank rotation angle from the crank rotation angle sensor; and receiving, by a motor controller, the crank rotation angle provided from the engine controller, temporally synchronizing the crank rotation angle and the motor control torque, and determining the engine torque correlation variable value based on the motor control torque.

According to an embodiment, the diagnosing may include determining, by the motor controller, an engine cycle and a cycle for each cylinder based on change of the crank rotation angle, and determining the engine torque correlation variable value for each cylinder cycle.

According to an embodiment, the diagnosing may include determining, by the motor controller, the engine torque correlation variable value by integrating an amount of change of the motor control torque matching one cycle for each cylinder.

According to an embodiment, the diagnosing may include diagnosing, by the motor controller, the misfire of the cylinder by comparing the engine torque correlation variable value with a preset misfire threshold.

According to an embodiment, the diagnosing may include: providing, by the motor controller, the engine torque correlation variable value to the engine controller, and diagnosing, by the engine controller, the misfire of the cylinder by comparing the engine torque correlation variable value with a preset misfire threshold.

According to an embodiment, the diagnosing may include determining, by the engine controller, crank angular acceleration based on the crank rotation angle, and diagnosing a misfire of the engine by comparing the crank angular acceleration with a preset misfire threshold.

According to an embodiment, the diagnosing may include providing, by the engine controller, the crank rotation angle to the motor controller when the crank angular acceleration is greater than or equal to the preset misfire threshold.

According to yet another embodiment of the present disclosure, a vehicle is provided. The vehicle includes: a power generation device including an engine, a motor configured to generate electrical energy based on power transmitted from the engine, and a crank rotation angle sensor provided on the engine to measure a crank rotation angle of the engine; and a controller configured to perform control of the engine and the motor and to diagnose a misfire for each cylinder of the engine based on the crank rotation angle and a motor control torque ouput to the motor when entering an engine power generation mode.

According to an embodiment, the vehicle may further include: a battery charged by receiving the electrical energy generated by the power generation device; and other electrical equipment configured to provide information, which the controller uses to determine whether to enter the engine power generation mode, to the controller.

Specific details of various examples of the present disclosure other than the means of solving problems mentioned above are included in the description and drawings below.

According to embodiments of the present disclosure, it is possible to provide a system implemented to improve the accuracy of engine misfire diagnosis of a vehicle including a power generation device (an engine and a motor), an engine misfire diagnosis method thereof, and a vehicle including the same.

According to embodiments of the present disclosure, it is possible to provide a system implemented to improve the accuracy of misfire diagnosis for each cylinder of an engine, an engine misfire diagnosis method thereof, and a vehicle including the same.

According to embodiments of the present disclosure, it is possible to provide a system implemented to diagnose engine/cylinder misfire based on the synchronization of a crank rotation angle and a motor control torque, an engine misfire diagnosis method thereof, and a vehicle including the same.

According to embodiments of the present disclosure, it is possible to provide a system implemented to synchronize a crank rotation angle and a motor control torque, determine an engine torque correlation variable value based on the motor control torque, and diagnose a misfire based on the engine torque correlation variable value, an engine misfire diagnosis method thereof, and a vehicle including the same.

In an engine misfire diagnosis technology according to embodiments of the present disclosure, it is possible to diagnose misfire for each cylinder of an engine based on the synchronization of a crank rotation angle and a motor control torque instead of engine roughness.

Accordingly, while conventional engine misfire diagnosis based on engine roughness has difficulty in accurately diagnosing engine misfire in an engine power generation mode, the engine misfire diagnosis technology according to embodiments of the present disclosure does not utilize engine roughness, thereby improving the accuracy of engine misfire diagnosis performed in an engine power generation mode.

Effects that can be obtained from the present disclosure are not limited to the effects mentioned above. Other effects not mentioned herein should be more clearly understood by those having ordinary skill in the art to which the present disclosure pertains from the description below.

### BRIEF DESCRIPTION OF THE DRAWINGS

FIG. 1 is a schematic view of a vehicle to which an engine misfire diagnosis technology according to an embodiment of the present disclosure is applied;

FIG. 2 is a view showing the detailed configuration of the vehicle of FIG. 1, according to an embodiment of the present disclosure;

FIG. 3 is a view showing a detailed configuration of a controller according to an embodiment of the present disclosure;

FIG. 4 is a graph showing synchronized states of a crank rotation angle and a motor control torque according to an embodiment of the present disclosure;

FIG. 5 is a flowchart showing a vehicle engine misfire diagnosis method according to an embodiment of the present disclosure; and

FIG. 6 is a flowchart showing a vehicle engine misfire diagnosis method according to another embodiment of the present disclosure.

### DETAILED DESCRIPTION

In the following description, where it was decided that a detailed description of known technologies related to the present disclosure would make the subject matter of the embodiments described herein unclear, the detailed description has been omitted. Further, the accompanying drawings are provided only to enhance understanding of embodiments disclosed in the present disclosure. The technical spirit of the present disclosure is not limited by the accompanying drawings, and all changes, equivalents, and replacements should be understood as being included in the spirit and scope of the present disclosure.

Terms including ordinal numbers such as “first”, “second”, etc. may be used to describe various components, but the components should not be construed as being limited to the terms. The terms are used only to distinguish one component from another component.

Singular forms are intended to include plural forms unless the context clearly indicates otherwise.

It should be further understood that the terms “comprise” or “have” used in this specification specify the presence of stated features, steps, operations, components, parts, or a combination thereof, but do not preclude the presence or addition of one or more other features, numerals, steps, operations, components, parts, or a combination thereof.

Terms “module” and “unit” that are used for components in the following description are used only for the convenience of description without having discriminate meanings or functions.

It should be understood that when one element is referred to as being “connected to” or “coupled to” another element, the element may be connected directly to, or coupled directly to, the other element, or the element may be connected to, or coupled to, the other element with one or more further elements intervening therebetween. On the other hand, it should be understood that when one element is referred to as being “connected directly to” or “coupled directly to” another element, the element may be connected, to or coupled to, the other element without any further elements intervening therebetween.

When a component, device, module, element, or the like of the present disclosure is described as having a purpose or performing an operation, function, or the like, the component, device, or element should be considered herein as being “configured to” meet that purpose or perform that operation or function.

Hereafter, embodiments of the present disclosure are described in detail with reference to the accompanying drawings. The same or similar components in the accompanying drawings are designated by the same reference numerals even when the elements are shown in different drawings, and are not repeatedly described.

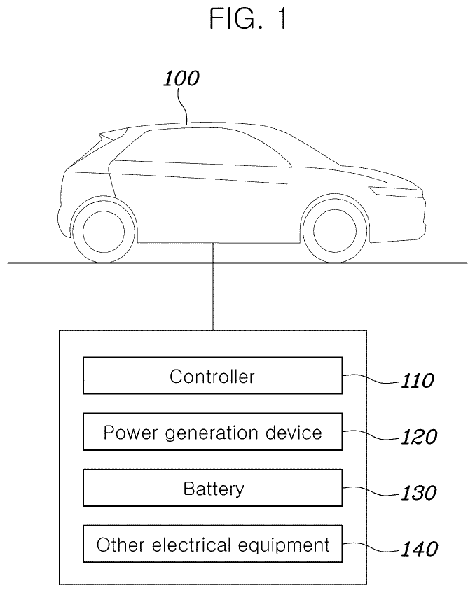

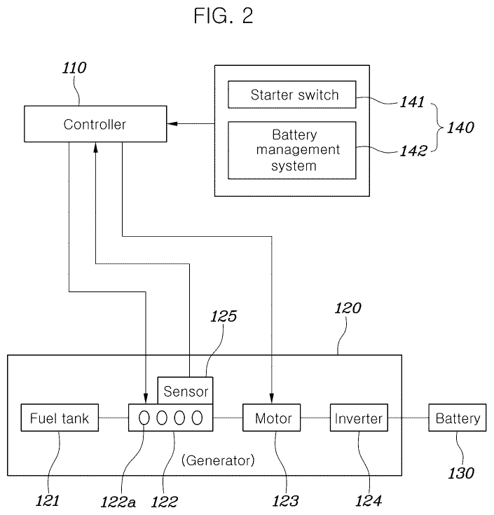

FIG. 1 is a schematic view of a vehicle 100 to which an engine misfire diagnosis technology according to an embodiment of the present disclosure is applied. FIG. 2 is a view showing the detailed configuration of the vehicle 100 of FIG. 1, according to an embodiment of the present disclosure.

Referring to FIGS. 1 and 2, a vehicle 100 may include a controller 110, a power generation device 120, a battery 130, and other electrical equipment 140. However, the components of the vehicle 100 are not limited thereto.

According to an embodiment, the controller 110 and the power generation device 120 may constitute, or may be included in, an engine misfire diagnosis system.

In an example, the vehicle 100 may be a vehicle equipped with a motor as a power source. In various examples, the vehicle 100 may be an electric vehicle (EV), and a hybrid electric vehicle (HEV), etc.

The controller 110 may perform communication with the power generation device 120 and the other electrical equipment 140 based on a preset vehicle communication protocol, and may transmit and receive data (or information), signals, etc.

For example, the vehicle communication protocol may include Local Interconnect Network (LIN), Controller Area Network (CAN), FlexRay, Ethernet, etc. However, the types of the vehicle communication protocol are not limited thereto.

The controller 110 may control the overall operation of the vehicle 100, such as driving control and driving mode setting related to the vehicle 100, based on input information such as required torque, a starting control signal, battery status, engine status, acceleration pedal displacement, deceleration pedal displacement, driving speed, and a transmission gear position.

According to an embodiment, the controller 110 may control the power generation device 120 so that the power generation device 120 generates electrical energy.

The controller 110 may control the power generation device 120 when entering an engine power generation mode.

According to an embodiment, when the controller 110 operates in the engine power generation mode, the controller 110 may synchronize an engine crank rotation angle and a motor control torque, and based on the motor control torque, may diagnose a misfire of the engine 122 and, further, a misfire of each cylinder 122a of the engine 122.

A detailed description of the configuration and operation of the controller 110, according to an embodiment, is provided below.

The power generation device 120 may generate electric energy by operating according to the control of the controller 110. The electric energy generated by the power generation device 120 may be used to charge the battery 130.

The battery 130, which may be a power source that supplies power required to drive the vehicle 100, is charged by the power generation device 120. As a result, the power generation device 120 may increase the driving distance of the vehicle 100.

According to an embodiment, the power generation device 120 may include a fuel tank 121, the engine 122, the motor 123, an inverter 124, and a crank rotation angle sensor 125. However, the components of the power generation device 120 are not limited thereto.

The fuel tank 121 may store liquid fuel (chemical energy), such as gasoline or diesel. Fuel stored in the fuel tank 121 may be supplied to the engine 122.

The engine 122, which may be a power source called an internal combustion engine (ICE), may include multiple cylinders 122a. For example, the engine 122 may include four cylinders. However, the number of cylinders is not limited thereto.

The engine 122 may generate mechanical energy (or power) by burning fuel supplied from the fuel tank 121. The mechanical energy generated by the engine 122 may be provided to the motor 123.

The motor 123 may operate as a generator and may be represented, for example, as an electric generator.

The motor 123 may generate electrical energy based on the mechanical energy provided by the engine 122.

For example, the motor 123 may be a wounded rotor synchronous motor (WRSM) or a wounded rotor synchronous machine (WRSM). However, the present disclosure is not limited thereto.

According to an embodiment, the motor 123 may be controlled by the controller 110. For example, the motor 123 may be controlled by a current output from the controller 110. Since torque is proportional to a current value, a current value output from the controller 110 may be represented as torque.

The inverter 124 may rectify electrical energy generated by the motor 123 and may supply the rectified electrical energy to the battery 130.

The crank rotation angle sensor 125 may be provided on the engine 122. The crank rotation angle sensor 125 may measure the crank rotation angle of the engine 122.

According to an embodiment, the crank rotation angle (or an engine crank angle or an engine crank rotation angle) may be provided to the controller 110 and may be used when the controller 110 diagnoses a misfire of the engine 122, and further, a misfire for each cylinder 122a.

The battery 130 may store electrical energy and may function as a direct current power source, for example.

According to an embodiment, the battery 130 may be charged by using electrical energy supplied from the power generation device 120 and may provide power to the drive motor of the vehicle 100.

The battery 130 may be managed by a battery management system (BMS) 142.

The other electrical equipment 140 may obtain information necessary for the operation of the controller 110 and may provide the obtained information to the controller 110.

For example, the other electrical equipment 140 may provide, to the controller 110, information that the controller 110 may use to determine whether to enter the engine power generation mode.

According to an embodiment, the other electrical equipment 140 may include a starter switch 141 and the battery management system 142. However, the components of the other electrical equipment 140 are not limited thereto.

The starter switch 141 may be implemented to receive an instruction related to starting from a user.

The starter switch 141 may provide starting status information to the controller 110 according to the instruction of a user. For example, the starter switch 141 may provide a start-on signal to the controller 110 according to the start-on instruction of a user.

The battery management system 142 may manage the battery 130 and may obtain status information of the battery 130. In an example, the battery management system 142 may provide the battery status information to the controller 110. In an example, the battery management system 142 may provide state of charging (SoC) information to the controller 110.

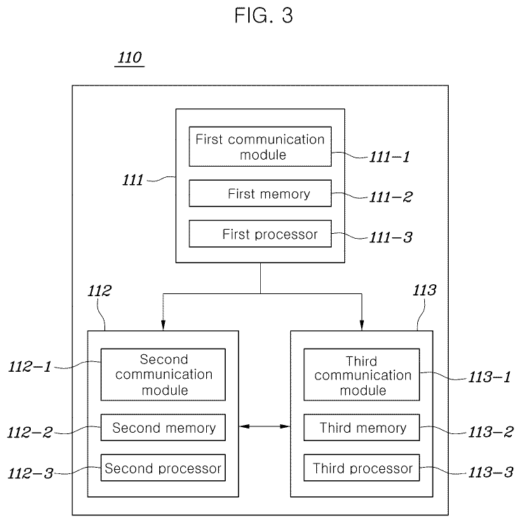

FIG. 3 is a view showing the detailed configuration of the controller 110 according to an embodiment of the present disclosure.

Referring to FIGS. 1-3, when the controller 110 enters the engine power generation mode, the controller 110 may synchronize the engine crank angle and the motor control torque, and based on the motor control torque, may diagnose a misfire of the engine 122 and, further, a misfire for each cylinder 122a.

According to an embodiment, the controller 110 may include a top-level controller 111, an engine controller 112, and a motor controller 113. However, the components of the controller 110 is not limited thereto.

The top-level controller 111, the engine controller 112, and the motor controller 113 may communicate with each other based on the vehicle communication protocol. For example, the vehicle communication protocol may be Controller Area Network (CAN) protocol. However, the present disclosure is not limited thereto.

The top-level controller 111 may enter the engine power generation mode when operation-required information provided from the other electrical equipment 140 satisfies an engine power generation mode entry condition. The top-level controller 111 may then output an engine power generation mode entry signal to the engine controller 112 and the motor controller 113.

Accordingly, the top-level controller 111, the engine controller 112, and the motor controller 113 may all enter the engine power generation mode.

According to an embodiment, the top-level controller 111 may receive a start-on signal from the starter switch 141 and may enter the engine power generation mode when the SoC provided from the battery management system 142 is below a preset threshold.

In an embodiment, the threshold may be defined as the amount of charge of the battery 130 required to drive the vehicle and may be set based on the results of various tests.

The top-level controller 111 may output a required torque command to the engine controller 112 and may output a rotation speed command to the motor controller 113.

In various examples, the top-level controller 111 may be implemented as a hybrid control unit (HCU), a vehicle control unit (VCU), or an electronic control unit (ECU).

According to an embodiment, the top-level controller 111 may include a first communication module 111-1, a first memory 111-2, and a first processor 111-3. However, the components of the top-level controller 111 are not limited thereto.

The first communication module 111-1 may be implemented to communicate with the other electrical equipment 140. For example, the first communication module 111-1 may receive information provided from the other electrical equipment 140 and transmit the received information to the first processor 111-3.

The first communication module 111-1 may be implemented to communicate with the engine controller 112 and the motor controller 113. For example, the first communication module 111-1 may output the required torque command and the rotation speed command transmitted from the first processor 111-3 to the engine controller 112 and the motor controller 113, respectively. For example, the first communication module 111-1 may transmit engine status information provided from the engine controller 112 and motor status information provided from the motor controller 113 to the first processor 111-3.

In various examples, the first communication module 111-1 may perform communication based on a communication protocol selected from among vehicle communication protocols such as Local Interconnect Network (LIN), Controller Area Network (CAN), FlexRay, Ethernet, etc.

The first memory 111-2 may store algorithms, data, etc., for performing the operation of the top-level controller 111. For example, the first memory 111-2 may store the characteristic map of required torque set based on an engine power generation mode entry determination algorithm, SoC threshold, and an operation point.

In an example, the first memory 111-2 may include volatile memory and/or non-volatile memory. The volatile memory may include dynamic random access memory (DRAM), static RAM (SRAM), synchronous DRAM (SDRAM), phase-change RAM (PRAM), magnetic RAM (MRAM), resistive RAM (RRAM), ferroelectric RAM (FeRAM), etc. The non-volatile memory may include read only memory (ROM), programmable ROM (PROM), electrically programmable ROM (EPROM), electrically erasable programmable ROM (EEPROM), flash memory, etc.

The first processor 111-3 may control vehicle driving based on algorithms/data stored in the first memory 111-2 and information provided from the other electrical equipment 140.

According to an embodiment, the first processor 111-3 may enter the engine power generation mode when the operation-required information provided from the other electrical equipment 140 satisfies the engine power generation mode entry condition and may output the engine power generation mode entry signal and the required torque command to the engine controller 112 and the motor controller 113.

In an example, the first processor 111-3 may be a data processing device implemented as hardware having circuits having a physical structure for executing desired operations. The desired operations may include codes or instructions included in a program, for example.

In various examples, the data processing device implemented as hardware may include a microprocessor, a central processing unit, a processor core, a multi-core processor, a multiprocessor, an application-specific integrated circuit (ASIC), and/or a field programmable gate array (FPGA).

The engine controller 112 may receive the engine power generation mode entry signal and the required torque command output from the top-level controller 111. The engine controller 112 may enter the engine power generation mode in response to the engine power generation mode entry signal. The engine controller 112 may then operate the engine 122 according to the required torque command so that the generator 123 connected to the engine 122 generates electrical energy.

Here, the control of the engine 122 by the engine controller 112 may be expressed as “engine generation control”, or “engine generation output control”, etc.

When the engine 122 is operating, the crank rotation angle sensor 125 provided on the engine 122 may measure the rotation angle (the engine crank angle) of the crank shaft of the engine 122 and may provide the measured crank rotation angle to the engine controller 112.

According to an embodiment, the engine controller 112 may provide the crank rotation angle to the motor controller 113.

Here, the crank rotation angle is related to the rotation of the crank shaft according to the operation of each cylinder 122a of the engine 122, and the operation cycle of the engine 122 and each cylinder 122a may be determined based on the amount of change of the crank rotation angle.

In a conventional technology, an engine controller and a motor controller operate independently, but according to embodiments of the present disclosure, since the engine controller 112 provides the crank rotation angle information to the motor controller 113, the engine controller 112 and the motor controller 113 may be connected to each other, and synchronization may be achieved between the engine controller 112 and the motor controller 113.

According to an embodiment, the engine controller 112 may determine an engine misfire by using an engine roughness method that utilizes engine variability determined based on the crank rotation angle.

For example, the engine controller 112 may determine a crank angular acceleration (engine roughness) based on the crank rotation angle, may compare the crank angular acceleration with a preset misfire threshold, and may determine an engine misfire when the crank angular acceleration is greater than or equal to the misfire threshold.

According to an embodiment, the engine controller 112 may diagnose a misfire for each cylinder based on the engine torque correlation variable value for each cylinder provided from the motor controller 113.

Here, the engine torque correlation variable value may correspond to the integral value of the motor control torque.

According to an embodiment, the engine controller 112 may include a second communication module 112-1, a second memory 112-2, and a second processor 112-3. However, the components of the engine controller 112 are not limited thereto.

The second communication module 112-1 may be implemented to communicate with the top-level controller 111 and the motor controller 113. The second communication module 112-1 may be implemented to communicate with the engine 122 and the crank rotation angle sensor 125.

In various examples, the second communication module 112-1 may perform communication based on a communication protocol selected from among vehicle communication protocols such as Local Interconnect Network (LIN), Controller Area Network (CAN), FlexRay, and/or Ethernet.

The second memory 112-2 may store algorithms, data, etc., for performing the operation of the engine controller 112. For example, the second memory 112-2 may store an engine power generation operation algorithm, a misfire diagnosis algorithm, and a misfire threshold, etc.

In various examples, the second memory 112-2 may include volatile memory and/or non-volatile memory. The volatile memory includes dynamic random access memory (DRAM), static RAM (SRAM), synchronous DRAM (SDRAM), phase-change RAM (PRAM), magnetic RAM (MRAM), resistive RAM (RRAM), ferroelectric RAM (FeRAM), etc. The non-volatile memory may include read only memory (ROM), programmable ROM (PROM), electrically programmable ROM (EPROM), electrically erasable programmable ROM (EEPROM), flash memory, etc.

The second processor 112-3 may perform an engine power generation operation and a misfire diagnosis based on algorithms/data, the crank rotation angle, the required torque command, etc., stored in the second memory 112-2.

According to an embodiment, the second processor 112-3 may be a data processing device implemented as hardware having circuits having a physical structure for executing desired operations. The desired operations may include codes or instructions included in a program, for example.

In various examples, the data processing device implemented as hardware may include a microprocessor, a central processing unit, a processor core, a multi-core processor, a multiprocessor, an application-specific integrated circuit (ASIC), and/or a field programmable gate array (FPGA).

The motor controller 113 may receive the engine power generation mode entry signal and the rotation speed command output from the top-level controller 111, may enter the engine power generation mode in response to the engine power generation mode entry signal, and may control the speed of the motor 123 based on the rotation speed command.

The motor controller 113 may control the motor 123 based on the rotation speed command. The motor controller 113 may use the motor control torque output to the motor 123 to determine the engine torque correlation variable value for each cylinder 122a.

Here, the control of the operation of the motor 123 by the motor controller 113 in the engine power generation mode may be expressed as “motor generation control” or “motor generation output control”, etc.

In the engine power generation mode, the motor controller 113 may be connected to the engine controller 112 and receive the crank rotation angle information from the engine controller 112.

According to an embodiment, when entering the engine power generation mode, the motor controller 113 may determine the engine torque correlation variable value for each cylinder 122a of the engine 122 based on the crank rotation angle and the motor control torque.

Here, the engine torque correlation variable value may correspond to the integral value of the motor control torque.

According to an embodiment, the motor controller 113 may temporally synchronize a change in the motor control torque with a change in the crank rotation angle, may determine an engine cycle and a cycle for each cylinder based on the change in the crank rotation angle, and may determine the engine torque correlation variable value for each cycle for each cylinder.

According to an embodiment, the motor controller 113 may determine the engine torque correlation variable value by integrating the amount of the change of the motor control torque within a section matching one cycle for each cylinder.

According to an embodiment, the motor controller 113 may provide the engine torque correlation variable value for each cylinder 122a to the engine controller 112.

According to an embodiment, the motor controller 113 may diagnose a misfire for each cylinder 122a based on the engine torque correlation variable value for each cylinder 122a. For example, the motor controller 113 may compare the engine torque correlation variable value with a preset misfire threshold, and may diagnose a corresponding cylinder to be in a misfire state when the engine torque correlation variable value is greater than or equal to the misfire threshold.

According to an embodiment, the motor controller 113 may include a third communication module 113-1, a third memory 113-2, and a third processor 113-3. However, the components of the motor controller 113 are not limited thereto.

The third communication module 113-1 may be implemented to communicate with the top-level controller 111 and the engine controller 112. The third communication module 113-1 may be implemented to communicate with the motor 123.

For example, the third communication module 113-1 may perform communication based on a communication protocol selected from among vehicle communication protocols such as Local Interconnect Network (LIN), Controller Area Network (CAN), FlexRay, and/or Ethernet.

The third memory 113-2 may store algorithms and data, etc., for performing the operation of the motor controller 113. For example, the third memory 113-2 may store an engine power generation operation algorithm, a misfire diagnosis algorithm, a misfire threshold, etc.

In an example, the third memory 113-2 may include volatile memory and/or non-volatile memory. The volatile memory may include dynamic random access memory (DRAM), static RAM (SRAM), synchronous DRAM (SDRAM), phase-change RAM (PRAM), magnetic RAM (MRAM), resistive RAM (RRAM), ferroelectric RAM (FeRAM), etc. The non-volatile memory may include read only memory (ROM), programmable ROM (PROM), electrically programmable ROM (EPROM), electrically erasable programmable ROM (EEPROM), flash memory, etc.

The third processor 113-3 may perform an engine power generation operation and a misfire diagnosis operation based on algorithms/data, the crank rotation angle, etc., stored in the third memory 113-2.

According to an embodiment, the third processor 113-3 may be a data processing device implemented as hardware having circuits having a physical structure for executing desired operations. For example, the desired operations may include codes or instructions included in a program.

For example, the data processing device implemented as hardware may include a microprocessor, a central processing unit, a processor core, a multi-core processor, a multiprocessor, an application-specific integrated circuit (ASIC), and/or a field programmable gate array (FPGA).

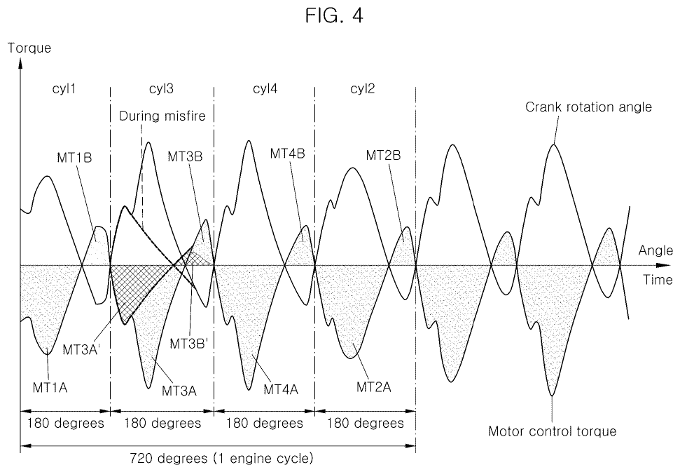

FIG. 4 is a graph showing synchronized states of the crank rotation angle and the motor control torque according to an embodiment of the present disclosure.

As illustrated in FIG. 4, the motor control torque has a phase opposite to that of the crank rotation angle. Within one engine cycle, there may be cycles (cyl1, cyl2, cyl3, and cyl4) for the first to fourth cylinders, respectively.

When the crank rotation angle and the motor control torque are synchronized, engine output torque corresponding to the crank rotation angle may be inferred based on the motor control torque. Being able to infer the engine output torque may mean that it is possible to diagnose whether the engine misfires and, further, diagnose whether each cylinder of the engine misfires.

According to an embodiment, the motor controller 113 may diagnose whether a cylinder 122a misfires based on the integral value of the motor control torque for each cylinder.

Accordingly, here, the integral value of the motor control torque, which is the engine torque correlation variable value, may correspond to a variable related to engine torque.

In FIG. 4, the integral value (MT1) of the motor control torque for a first cylinder during normal operation may be inferred as the sum (MT1A+MT1B) of the integral values of the motor control torque during the downward and upward movements of the first cylinder.

Likewise, the integral values (MT2, MT3, MT4) of the motor control torque for second to fourth cylinders during normal operation can be respectively inferred as the sums (MT2A+MT2B, MT2A+MT2B, MT2A+MT2B) of the integral values of the motor control torque during the downward and upward movements of the second to fourth cylinders.

When a misfire occurs in a cylinder, the motor control torque changes. Accordingly, the integral value of the motor control torque for the cylinder in which the misfire occurs also changes. In FIG. 4, a case in which a misfire occurs in the third cylinder (corresponding to cyl3) is illustrated, and the integral value (TM3′) of the motor control torque for the third cylinder in which the misfire occurs is different from the integral value (TM3) of the motor control torque for the third cylinder during normal operation.

According to an embodiment, a misfire threshold may be set the same or different for each cylinder.

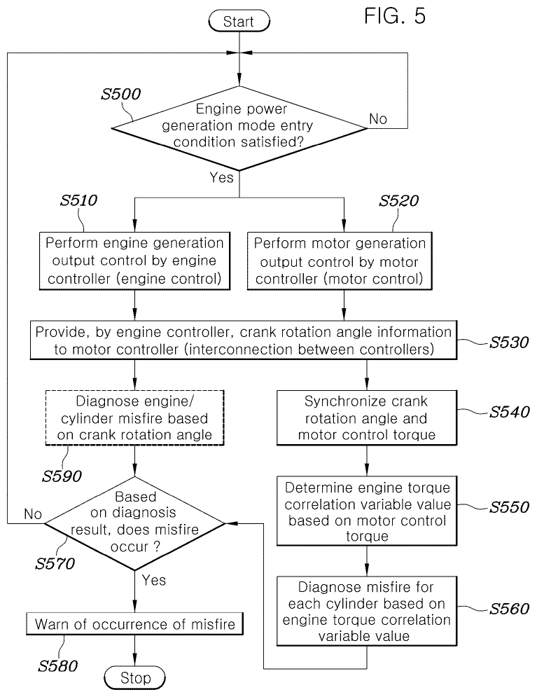

FIG. 5 is a flowchart showing a vehicle engine misfire diagnosis method, according to an embodiment of the present disclosure.

Operations illustrated in FIG. 5 may be performed by the vehicle engine misfire diagnosis system described with reference to FIGS. 1-4, for example.

Referring to FIGS. 1-5, in an operation S500, the top-level controller 111 may determine whether the engine power generation mode entry condition is satisfied. The top-level controller 111 may enter the engine power generation mode when the engine power generation mode entry condition is satisfied (Yes in the operation S500).

In the operation S500, the top-level controller 111 may receive a start-on signal from the starter switch 141 and may enter the engine power generation mode when the SoC provided from the battery management system 142 is below a preset threshold.

According to an embodiment, the top-level controller 111 may enter the engine power generation mode and may then output an engine power generation mode entry signal to the engine controller 112 and the motor controller 113 so that the engine controller 112 and the motor controller 113 also enter the engine power generation mode.

According to an embodiment, the top-level controller 111 may output the required torque command to the engine controller 112 and may output the rotation speed command to the motor controller 113.

When the engine controller 112 receives the engine power generation mode entry signal, the engine controller 112 may enter the engine power generation mode and may control the engine 122 based on the required torque command output from the top-level controller 111 in an operation S510.

Here, the control of the engine 122 by the engine controller 112 in the engine power generation mode may be referred to as “the engine generation output control”.

In the operation S510, during the engine generation output control, the engine controller 112 may receive the crank rotation angle provided from the crank rotation angle sensor 125 provided on the engine 122.

According to an embodiment, the engine controller 112 may provide the crank rotation angle information to the motor controller 113.

When the motor controller 113 receives the engine power generation mode entry signal, the motor controller 113 may enter the engine power generation mode and may control the motor 123 based on the rotation speed command output from the top-level controller 111 in an operation S520.

Here, control of the motor 123 by the motor controller 113 in the engine power generation mode may be referred to as “the motor generation output control”.

In the operation S520, during the motor generation output control, the motor controller 113 may obtain the motor control torque output to the motor 123 for controlling the motor 123.

As the engine controller 112 provides the crank rotation angle information to the motor controller 113, the engine controller 112 and the motor controller 113 may be connected to each other in an operation S530.

In an operation S540, the motor controller 113 may temporally synchronize the crank rotation angle and the motor control torque provided from the engine controller 112. In an operation S550, the motor controller 113 may determine the engine torque correlation variable value based on the motor control torque based on the change of the crank rotation angle.

In the operation S550, the motor controller 113 may determine an engine cycle and a cycle of each cylinder based on the change of the crank rotation angle, and may determine the engine torque correlation variable value for each cylinder cycle.

In the operation S550, the motor controller 113 may determine the engine torque correlation variable value by integrating the amount of the change of the motor control torque within a section matching one cycle for each cylinder.

In an operation, the motor controller 113 may diagnose a misfire for each cylinder based on the engine torque correlation variable value.

In the operation S560, the motor controller 113 may compare the engine torque correlation variable value with a preset misfire threshold, and may diagnose a corresponding cylinder to be in a misfire state when the engine torque correlation variable value is greater than or equal to the misfire threshold.

The motor controller 113 may provide a misfire diagnosis result to the engine controller 112. The engine controller 112 may determine whether a misfire has occurred in each cylinder based on the misfire diagnosis result provided from the motor controller 113 in an operation S570.

When the engine controller 112 determines that the misfire has occurred (Yes in the operation S570), the engine controller 112 may warn of the occurrence of the misfire in an operation S580.

For example, the vehicle 100 may be provided with an output device, such as a sound generating device, a display device, and a warning light. The engine controller 112 may output a misfire occurrence signal to the output device so that the output device may warn of a misfire occurrence.

For example, the engine controller 112 may provide the misfire occurrence signal to the top-level controller 111 so that the top-level controller 111 may use the output device to warn of the misfire occurrence.

On the other hand, when the motor controller 113 determines that no misfire has occurred in (No in the operation S570), the method may return to the operation S500.

According to an embodiment, the engine controller 112 may further diagnose the misfire of the engine 122 based on the crank rotation angle in an operation S590.

In the operation S590, the engine controller 112 may determine the crank angular acceleration (engine roughness) based on the crank rotation angle, compare the crank angular acceleration with a preset misfire threshold, and may diagnose an engine misfire when the crank angular acceleration is greater than or equal to the misfire threshold.

After the operation S590, the engine controller 112 may perform the operation S570.

When the engine controller 112 diagnoses a misfire in the operation S570, the engine controller 112 may determine whether a misfire has occurred based on the misfire diagnosis performed according to the operation S590 and the misfire diagnosis performed by the motor controller 113.

According to an embodiment, when the engine controller 112 is implemented to be capable of diagnosing a misfire, the engine controller 112 may provide the crank rotation angle to the motor controller 113 when the engine controller 112 diagnoses that a misfire has occurred, so that the motor controller 113 may perform a misfire diagnosis.

According to an embodiment, when the engine controller 112 determines that a misfire has occurred (Yes in the operation S570), the engine controller 112 may control the amount of air or fuel injected into a cylinder in which the misfire has occurred.

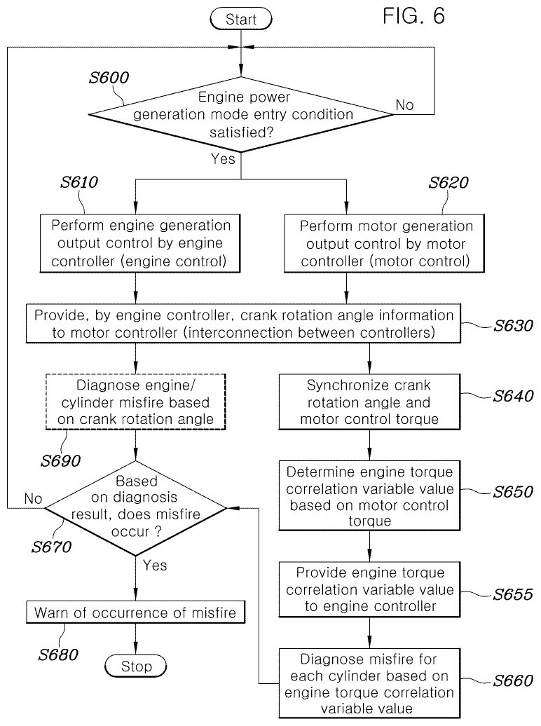

FIG. 6 is a flowchart showing a vehicle engine misfire diagnosis method according to another embodiment of the present disclosure.

In the vehicle engine misfire diagnosis method according to a first embodiment (the embodiment of FIG. 5), the motor controller 113 diagnoses a misfire for each cylinder based on the engine torque correlation variable value, whereas in the vehicle engine misfire diagnosis method according to a second embodiment, the engine controller 112 diagnoses a misfire for each cylinder based on the engine torque correlation variable value.

Hereinafter, the vehicle engine misfire diagnosis method according to the second embodiment is described with reference to FIG. 6. Operations identical to those of the vehicle engine misfire diagnosis method according to the embodiment of FIG. 5 have been described briefly or omitted.

Referring to FIG. 6, operations S600-S650 are identical to the operations S500-S550 of FIG. 5.

After the operation S650, the motor controller 113 may provide the engine torque correlation variable value to the engine controller 112 in S655. The engine controller 112 may diagnose a misfire for each cylinder based on the engine torque correlation variable value in an operation S660.

Operations S670-S690 are identical to the operations S570-S590 of FIG. 5.

Although the embodiments of the present disclosure have been described in detail with reference to the attached drawings, the present disclosure is not limited to these embodiments. Various modifications may be implemented without departing from the technical spirit of the present disclosure. Accordingly, the embodiments disclosed in this specification are intended to illustrate rather than limit the technical idea of the present disclosure. The scope of the technical idea of the present disclosure is not limited by these embodiments. Therefore, it should be understood that the embodiments described above are illustrative and not restrictive in all respects. The scope of protection of the present disclosure should be interpreted by the scope of the claims, and all technical ideas within a scope equivalent thereto should be interpreted as being included in the scope of the claims of the present disclosure.

What is claimed is:

1. An engine misfire diagnosis system comprising:
an engine configured to output power based on supplied fuel;
a crank rotation angle sensor provided on the engine to measure a crank rotation angle of the engine;
a motor configured to generate electrical energy by receiving the power; and
a controller configured to perform control of the engine and the motor, wherein the controller is configured to diagnose a misfire for each cylinder of the engine based on the crank rotation angle and a motor control torque ouput to the motor when entering an engine power generation mode.

2. The engine misfire diagnosis system of claim 1, wherein the controller is configured to:
temporally synchronize the crank rotation angle and the motor control torque;
determine an engine torque correlation variable value based on the motor control torque; and
diagnose the misfire for each cylinder based on the engine torque correlation variable value.

3. The engine misfire diagnosis system of claim 2, wherein the controller includes:
an engine controller configured to receive the crank rotation angle from the crank rotation angle sensor; and
a motor controller configured to
receive the crank rotation angle provided from the engine controller,
temporally synchronize the crank rotation angle and the motor control torque, and
determine the engine torque correlation variable value based on the motor control torque.

4. The engine misfire diagnosis system of claim 3, wherein the motor controller is configured to:
determine an engine cycle and a cycle of each cylinder based on change of the crank rotation angle; and
determine the engine torque correlation variable value for each cylinder cycle.

5. The engine misfire diagnosis system of claim 3, wherein the motor controller is configured to determine the engine torque correlation variable value by integrating an amount of change of the motor control torque matching one cycle for each cylinder.

6. The engine misfire diagnosis system of claim 3, wherein the motor controller is configured to diagnose the misfire of the cylinder by comparing the engine torque correlation variable value with a preset misfire threshold.

7. The engine misfire diagnosis system of claim 3, wherein:
the motor controller is configured to provide the engine torque correlation variable value to the engine controller; and
the engine controller is configured to diagnose the misfire of the cylinder by comparing the engine torque correlation variable value with a preset misfire threshold.

8. The engine misfire diagnosis system of claim 3, wherein the engine controller is configured to:
determine crank angular acceleration based on the crank rotation angle; and
diagnose a misfire of the engine by comparing the crank angular acceleration with a preset misfire threshold.

9. The engine misfire diagnosis system of claim 8, wherein the engine controller is configured to provide the crank rotation angle to the motor controller when the crank angular acceleration is greater than or equal to the preset misfire threshold.

10. An engine misfire diagnosis method comprising:
entering an engine power generation mode;
controlling an engine and a motor configured to generate electrical energy based on power transmitted from the engine; and
diagnosing a misfire for each cylinder of the engine based on a crank rotation angle measured by a crank rotation angle sensor provided on the engine and a motor control torque output to the motor.

11. The engine misfire diagnosis method of claim 10, wherein diagnosing the misfire includes:
synchronizing the crank rotation angle and the motor control torque temporally;
determining an engine torque correlation variable value based on the motor control torque; and
diagnosing the misfire for each cylinder based on the engine torque correlation variable value.

12. The engine misfire diagnosis method of claim 11, wherein diagnosing the misfire includes:
receiving, by an engine controller, the crank rotation angle from the crank rotation angle sensor;
receiving, by a motor controller, the crank rotation angle provided from the engine controller;
temporally synchronizing, by the motor controller, the crank rotation angle and the motor control torque; and
determining, by the motor controller, the engine torque correlation variable value based on the motor control torque.

13. The engine misfire diagnosis method of claim 12, wherein diagnosing the misfire includes:
determining, by the motor controller, an engine cycle and a cycle for each cylinder based on change of the crank rotation angle; and
determining, by the motor controller, the engine torque correlation variable value for each cylinder cycle.

14. The engine misfire diagnosis method of claim 12, wherein diagnosing the misfire includes determining, by the motor controller, the engine torque correlation variable value by integrating an amount of change of the motor control torque matching one cycle for each cylinder.

15. The engine misfire diagnosis method of claim 12, wherein diagnosing the misfire includes diagnosing, by the motor controller, the misfire of the cylinder by comparing the engine torque correlation variable value with a preset misfire threshold.

16. The engine misfire diagnosis method of claim 12, wherein diagnosing the misfire includes:
providing, by the motor controller, the engine torque correlation variable value to the engine controller, and
diagnosing, by the engine controller, the misfire of the cylinder by comparing the engine torque correlation variable value with a preset misfire threshold.

17. The engine misfire diagnosis method of claim 12, wherein diagnosing the misfire includes:
determining, by the engine controller, crank angular acceleration based on the crank rotation angle; and
diagnosing, by the engine controller, a misfire of the engine by comparing the crank angular acceleration with a preset misfire threshold.

18. The engine misfire diagnosis method of claim 17, wherein diagnosing the misfire includes providing, by the engine controller, the crank rotation angle to the motor controller when the crank angular acceleration is greater than or equal to the preset misfire threshold.

19. A vehicle comprising:
a power generation device including an engine, a motor configured to generate electrical energy based on power transmitted from the engine, and a crank rotation angle sensor provided on the engine to measure a crank rotation angle of the engine; and
a controller configured to perform control of the engine and the motor, wherein the controller is configured to diagnose a misfire for each cylinder of the engine based on the crank rotation angle and a motor control torque ouput to the motor when entering an engine power generation mode.

20. The vehicle of claim 19, further comprising:
a battery charged by receiving the electrical energy generated by the power generation device; and
other electrical equipment configured to provide information to the controller, wherein the controller is configured to use the information provided from the other electrical equipment to determine whether to enter the engine power generation mode.
